(19) United States
(12) Patent Application Publication
(10) Pub. No.: US 2008/0180945 A1
(43) Pub. Date: Jul. 31, 2008

(54) Multi-function penlight structure

(76) Inventor: Leo Shih, Taichung (TW)

Correspondence Address: PRO-TECHTOR INTERNATIONAL SERVICES, 20775 NORADA CT., SARATOGA, CA, 95070, US

(21) Appl. No.: 11/699,896

(22) Filed: Jan. 29, 2007

(51) Int. Cl. F21L 4/06

(52) U.S. Cl. 362/205

(57) ABSTRACT

A multi-function penlight structure comprises a body provided with a cell, a power button and an illuminative casing, in the outer front periphery of the illuminative casing being mounted a magnetic collar, and at the rear end of the body being formed a grip portion in which an extendable and retractable stem is received, and at the front end of the stem being attached a flexible member for connecting with the body, such that the penlight body can be extended, retracted and bent to any desired angle so as to attract a metal object by using the magnetic collar, and after retracting the stem and the flexible member back to the grip portion, the present invention can be simply used as a penlight, thereby achieving the multi-function purposes thereof.

### BACKGROUND OF THE INVENTION

1. Field of the Invention

The present invention relates to a penlight structure, and more particularly to a multi-function penlight structure that can utilize its extendable, retractable and bendable functions to cause an illumination and an object attachment thereon in different conditions.

2. Description of the Prior Arts

Normally, the length of a prior art flashlight is limited within a certain range for portable or storable convenience, however, such a conventional flashlight can not be widely applied in some special conditions, e.g., while in a car maintenance, some related parts of the car are located in narrowly complicated positions, hence the flashlight is not permitted to directly illuminate at the desired positions, or while in the maintenances of large machines, the length of the conventional flashlight is too short to provide a long distance illumination, or as suffering some shades, the flashlight can not be extended into the illumination-required position and change its illuminative angle. As shown in FIG. 1, to solve such a problem, an improved illumination light 10 has been developed and includes a fastening seat 11 in which a cell (not shown) and a power switch are mounted for matingly retaining it onto a fixed object, one end of the fastening seat 11 provided with a flexible wire 12, another end of which is coupled to an illuminative casing 13. Although such an improved illumination light 10 can be utilized to change its illuminative angle for different requirements, it still has some defects as follows:

1. The flexible wire 12 is not easy to be retractable, hence its length can not be designed in a quite long length, thus resulting in a length limitation thereof such that a long-distance illumination are unable to be achieved.

2. Likewise, since the flexible wire 12 is not easily retractable, thus causing an inconvenient storage thereof.

3. Such an improved illumination light is only for use in some certain conditions but not for use as a flashlight, and a handle is not attached to it, besides, the flexible wire 12 is not easily retractable, thereby causing a portable inconvenience and a limited usage.

The present invention has arisen to mitigate and/or obviate the afore-described disadvantages.

### SUMMARY OF THE INVENTION

The primary objective of the present invention is to provide a multi-function penlight structure comprises a body and a grip portion at the rear end of the body, in the grip portion being received an extendable and retractable stem, and at the front end of the stem being attached a flexible member for connecting with the body, such that the penlight body can be extendable, retractable and bendable to any desired angle for use in some special conditions.

Further objective of the present invention is to provide a multi-function penlight structure comprises the extendable and retractable stem received in the grip portion, and the flexible member attached at the front end of the stem for connecting with the body, the stem and the flexible member both are stored in the grip portion, thereby obtaining an easily storage and a portable convenience.

Another objective of the present invention is to provide a multi-function penlight structure further comprises a magnetic collar mounted in the outer front periphery of the illuminative casing, such that the penlight body can be extended, retracted and bent to any desired angle so as to attract a metal object by using the stem and the flexible member.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a conventional improved illumination light;

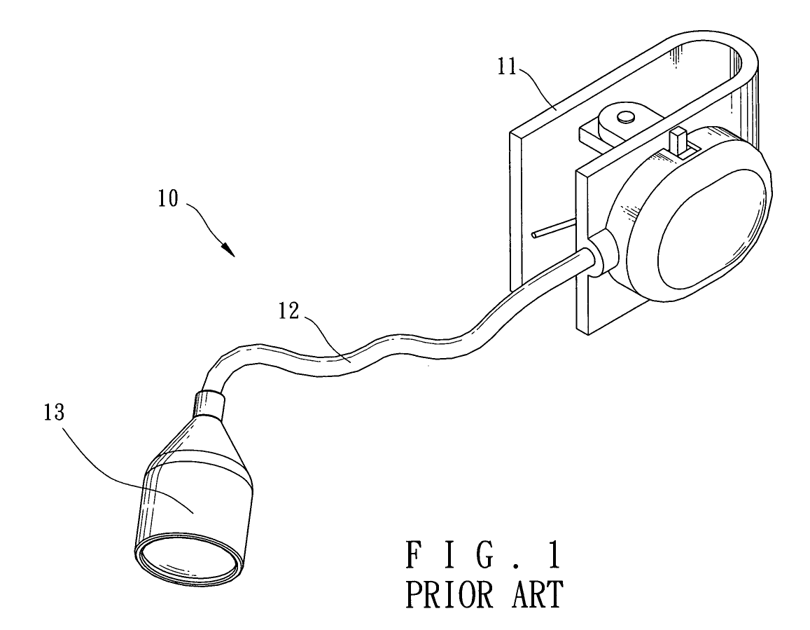

FIG. 2 is an exploded view of illustrating a multi-function penlight structure in accordance wit the present invention;

FIG. 3 is a perspective view of the multi-function penlight structure in accordance wit the present invention;

FIG. 4 is an operational view of illustrating the illuminative distance of the present invention being extended;

FIG. 5 is an operational view of illustrating the illuminative angle of the present invention being changed;

FIG. 6 is an operational view of illustrating the present invention being used to attract a metal object;

FIG. 7 illustrates the present invention being stored only for the use of the penlight.

### DETAILED DESCRIPTION OF THE PREFERRED EMBODIMENT

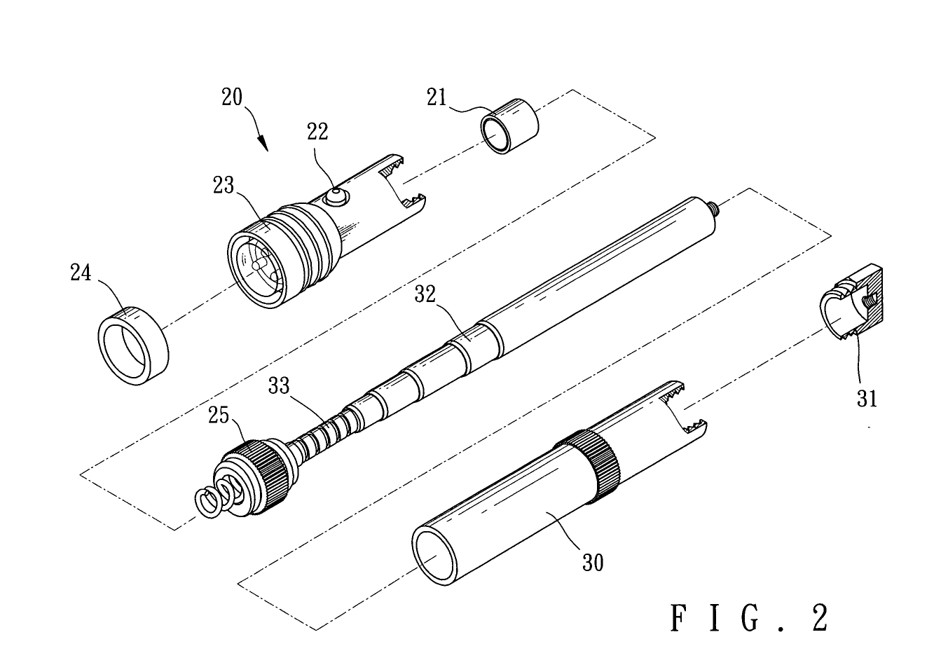

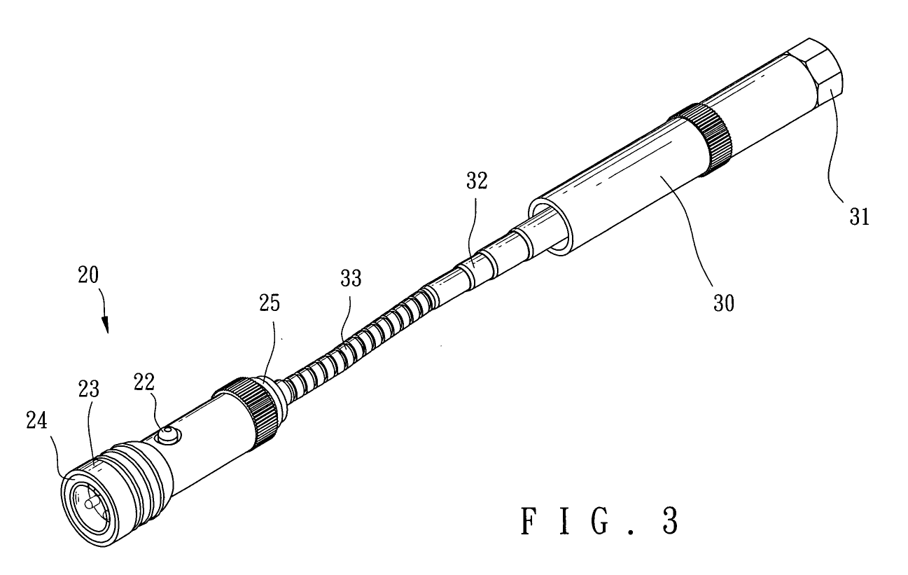

Referring to FIGS. 2-3, a multi-function penlight structure in accordance with the present invention comprises a body 20 and a grip portion 30, the body 20 including a cell 21 and a power button 22 therein and provided at the front end thereof with an illuminative casing 23, at the outer front periphery of the illuminative casing 23 being mounted a magnetic collar 24 for matingly attracting a metal object thereon, and at the rear end of the body 20 being secured a cover member 25 for retaining the cell 21 in the body 20. A hollow cylindrical grip portion 30 is defined at the rear end thereof with a fastening seat 31 in which an extendable and retractable stem 32 is retained and extended through the grip portion 30, and at the front end of the stem 32 is fixed a flexible member 33 which is stored in the stem 32 and connected to the cover member 25 such that the penlight body can be extended, retracted and bent to any desired angle.

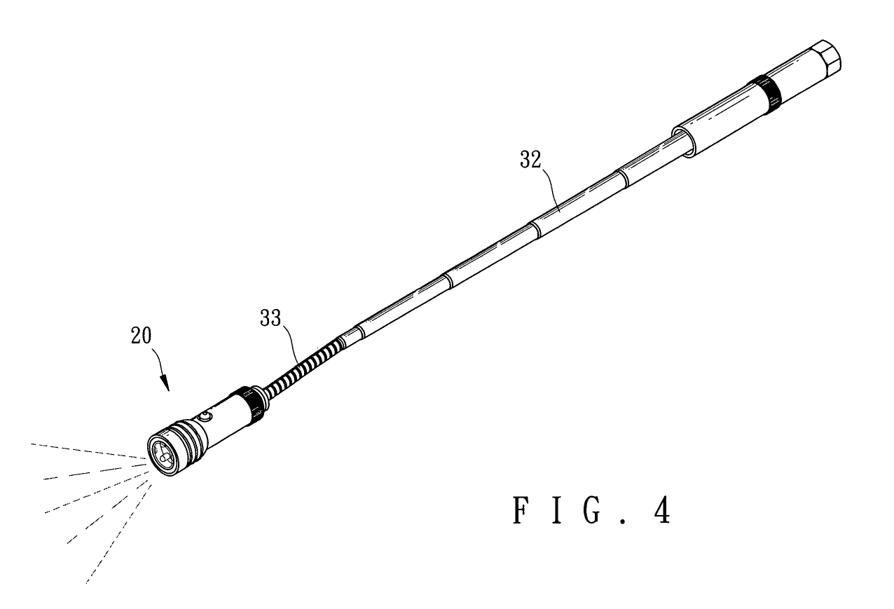

With reference to FIG. 4, while the present invention is in use for special conditions, the stem 32 is extended so as to pull the body 20 forwardly, such that the penlight can be formed in the shaped of an elongated rod, and since the body 20 is located at the front end of the stem 32, such a penlight is permitted to illuminate the object at a short distance.

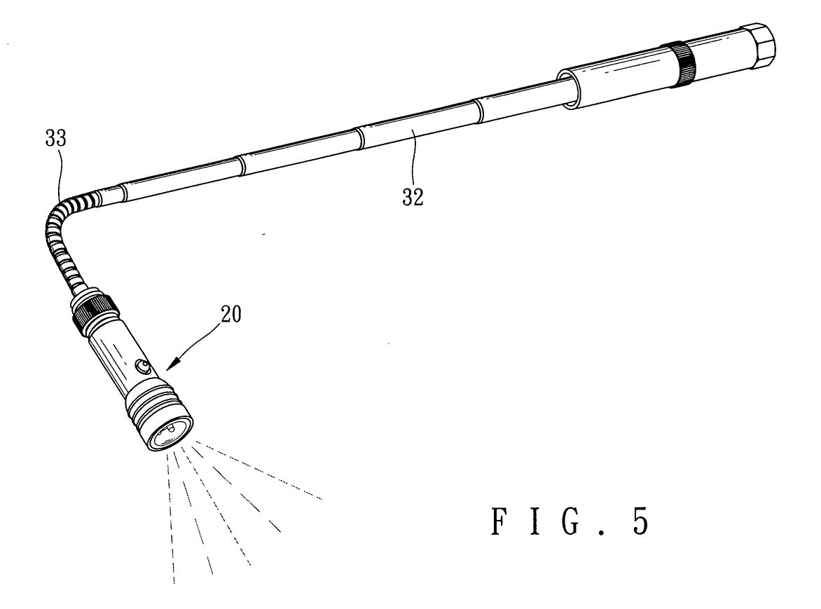

With reference to FIG. 5, in the operation of bending the flexible member 33 for use in a certain condition, the body 20 is bent to a desired angle so as to face toward the object and to avoid shades, thereby effectively illuminating the object.

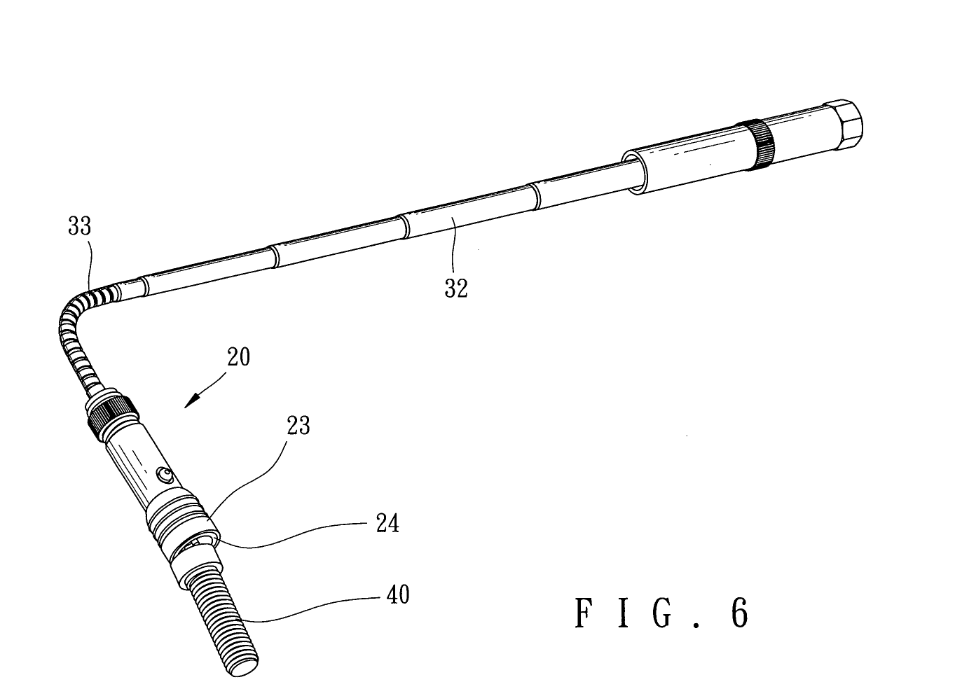

As shown in FIG. 6, due to the magnetic collar 24 is mounted in the outer front periphery of the illuminative casing 23, by way of the stem 32 and the flexible 33, the penlight is allowed to matingly attract the metal object 40 thereon at a long distance or a narrowly complicated space, thus achieving multi-function purpose such as illumination and object picking and the like purposes.

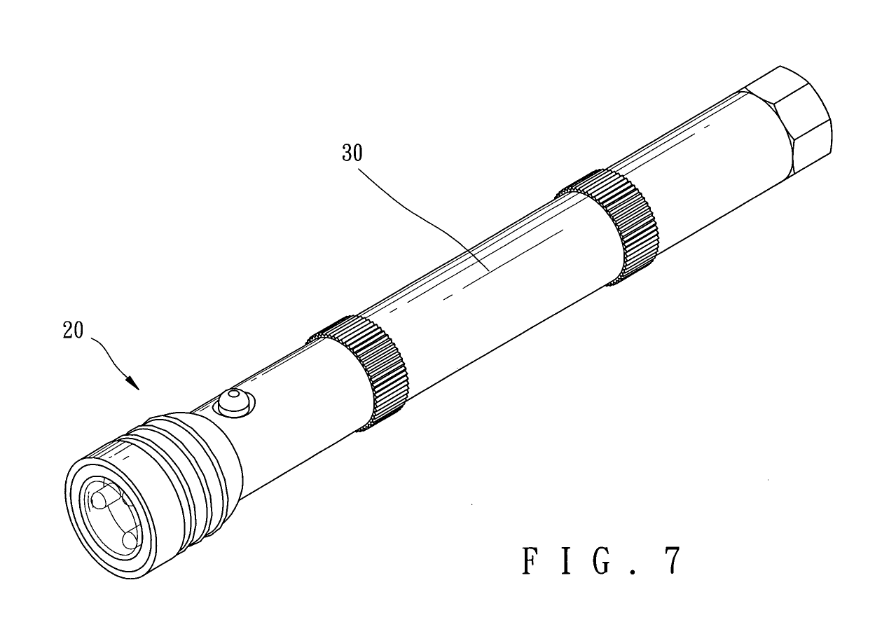

As shown in FIGS. 3 and 7, since the stem 32 is storably received in the grip portion 30, and the flexible member 33 is received in the grip portion 30 as well, after retracting of the stem 32 and the flexible member 33 back to the grip portion 30, the body 20 is couplingly fitted to the end periphery of the grip portion 30, thus permitting use only for a penlight.

The invention is not limited to the above embodiment but various modifications thereof may be made. It will be understood by those skilled in the art that various changes in form and detail may made without departing from the scope and spirit of the present invention.

What is claimed is:

1. A multi-function penlight structure comprising:
a body including a cell and a power button therein and provided at the front end thereof with an illuminative casing, at the outer front periphery of said illuminative casing being mounted a magnetic collar;
a grip portion in the form of a hollow cylinder received an extendable and retractable stem therein, and the front end of said stem fixed a flexible member, the front end of which is connected to said body.

2. The multi-function penlight structure as claimed in claim 1, wherein at the rear end of said body is secured a cover member for retaining said cell in said body.

3. The multi-function penlight structure as claimed in claim 1, wherein said grip portion is defined at the rear end thereof with a fastening seat in which said stem is retained and extended therethrough.

4. The multi-function penlight structure as claimed in claim 1, said flexible member is stored in said stem.

5. The multi-function penlight structure as claimed in claim 1, wherein the front end of said flexible member of said grip portion is connected a cover member at the rear end of said body.
